(19) United States
(12) Patent Application Publication
(10) Pub. No.: US 2015/0070498 A1
(43) Pub. Date: Mar. 12, 2015

(54) Image Display System

(71) Applicant: Caterpillar Inc., Peoria, IL (US)

(72) Inventor: Bradley S. Kriel, Pittsburgh, PA (US)

(73) Assignee: Caterpillar Inc., Peoria, IL (US)

(21) Appl. No.: 14/020,468

(22) Filed: Sep. 6, 2013

(51) Int. Cl. G06K 9/00; B60R 11/04; H04N 7/18

(52) U.S. Cl. CPC G06K 9/00805; H04N 7/183; B60R 11/04
USPC 348/148

(57) ABSTRACT

An image display system includes a visual image system for generating image data from a plurality of points of view, an object detection system for detecting objects, and a machine sensor for sensing a state of the machine. A controller receives the image data, generates a unified image by combining the image data, and detects any objects in proximity to the machine. The controller further senses a state of the machine, determines an image to be rendered based upon the state of the machine and any detected objects, and renders the image on a display device.

### TECHNICAL FIELD

This disclosure relates generally to an image display system, and more particularly, to a system and method for selecting and rendering an image based upon objects detected adjacent to a movable machine and a state of the machine.

### BACKGROUND

Movable machines such as haul trucks, dozers, motor graders, excavators, wheel loaders, and other types of equipment are used to perform a variety of tasks. For example, these machines may be used to move material and/or alter work surfaces at a work site. The machines may perform operations such as digging, loosening, carrying, etc., different materials at the work site.

Due to the size and configuration of these machines, an operator may have a limited field of view with respect to the environment in which a machine is operating. Accordingly, some machines may be equipped with image processing systems including cameras. The cameras capture images of the environment around the machine, and the image processing system renders the images on a display within an operator station of the machine to increase the visibility around the machine.

While improving visibility, such image processing systems may not identify obstacles in the operating environment adjacent the machines. As a result, while an operator may monitor an image from the image processing system, the operator may not appreciate that obstacles are in proximity to the machine and, in particular, within a blind spot of the machine.

Some machines further include an object detection system having a plurality of sensors to sense objects that are adjacent the machine. Such an object detection system will typically provide a signal or an alarm if an object is detected that is within a predetermined distance from the machine. However, while operating a machine to perform a desired task, operators process a significant amount of information and, as a result, alarms and visual indicators of Obstacles are sometimes missed or ignored.

A system that may be used to improve visibility is disclosed in U.S. Patent Application Publication 2012/0262580, The system of the '580 Publication provides a surround view from a vehicle by way of cameras positioned at various locations on the vehicle. The cameras can generate image data corresponding to the surround view, and a processing device can process the image data and generate the surround view on a simulated predetermined shape that can be viewed from a display. The simulated predetermined shape can have a flat bottom with a rectangular shape and a rim with a parabolic shape. Although the system of the '580 Publication may increase visibility, it does not necessarily increase safety as the entire surround view is displayed.

The foregoing background discussion is intended solely to aid the reader, It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein, The implementations and application of the innovations described herein are defined by the appended claims.

### SUMMARY

In one aspect, an image display system includes a visual image system mounted on a machine for generating image data from a plurality of points of view relative to the machine, an object detection system associated with the machine for detecting objects in proximity to the machine, and a machine sensor associated with the machine for sensing a state of the machine, A controller is configured to receive the image data from the visual image system, generate a unified image by combining the image data from the plurality of points of view, and detect any objects in proximity to the machine. The controller is further configured to sense a state of the machine, determine an image to be rendered based upon the state of the machine and any objects detected in proximity to the machine, and render the image on a visual image display device.

In another aspect, a method of operating an image display system includes receiving image data from a visual image system mounted on a machine for generating image data from a plurality of points of view relative to the machine, generating a unified image by combining the image data from the plurality of points of view, and detecting any objects in proximity to the machine. The method further includes sensing a state of the machine based upon a machine sensor associated with the machine, determining an image to be rendered based upon the state of the machine and any Objects detected in proximity to the machine, and rendering the image on a visual image display device.

In still another aspect, a machine includes a propulsion system, a visual image system mounted on the machine for generating image data from a plurality of points of view relative to the machine, an object detection system associated with the machine for detecting objects in proximity to the machine, and a machine sensor associated with the machine for sensing a state of the machine. A controller is configured to receive the image data from the visual image system, generate a unified image by combining the image data from the plurality of points of view, and detect any objects in proximity to the machine. The controller is further configured to sense a state of the machine, determine an image to be rendered based upon the state of the machine and any objects detected in proximity to the machine, and render the image on a visual image display device.

### BRIEF DESCRIPTION OF THE DRAWINGS

FIG. 1 is a perspective view of a machine at a work site in accordance with the disclosure;

FIG. 2 is a diagrammatic view of an operator station of the machine of FIG. 1;

FIG. 3 is a top plan view of another machine in accordance with the disclosure;

FIG. 4 is a schematic view of a visual image system generating an unified image in accordance with the disclosure;

FIG. 5 is a flowchart of a process for generating an image to be displayed;

FIG. 6 is a flowchart of a process for selecting and displaying an image with the transmission of a machine in neutral;

FIG. 7 is a flowchart of a process for selecting and displaying an image with the transmission of a machine in drive; and

FIG. 8 is a flowchart of a process for selecting and displaying an image with the transmission of a machine in reverse.

### DETAILED DESCRIPTION

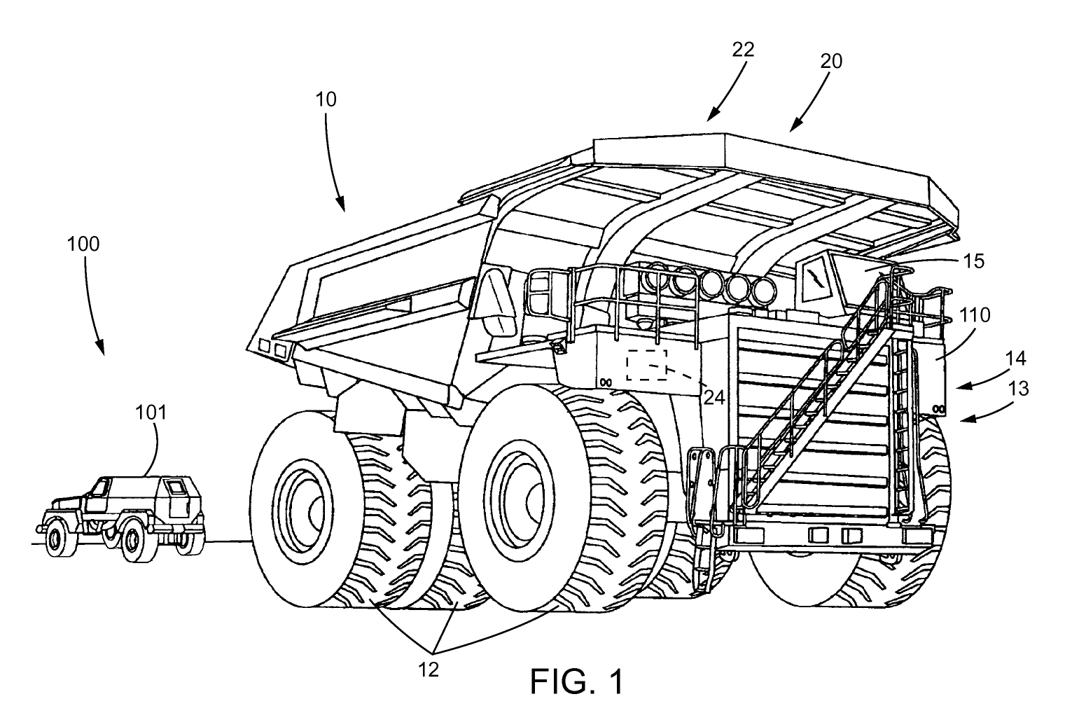

FIG. 1 illustrates an exemplary work site 100 with a machine 10 operating at the work site. Work site 100 may include, for example, a mine site, a landfill, a quarry, a construction site, a road work site, or any other type of work site. Machine 10 may perform any of a plurality of desired operations or tasks at work site 100, and such operations or tasks may require the machine to generally traverse work site 100. Any number of machines 10 may simultaneously and cooperatively operate at work site 100, as desired. Machine 10 may embody any type of machine. For example, machine 10 may embody a mobile machine such as the haul truck depicted in FIG. 1, a service truck, a wheel loader, a dozer, or another type of mobile machine known in the art.

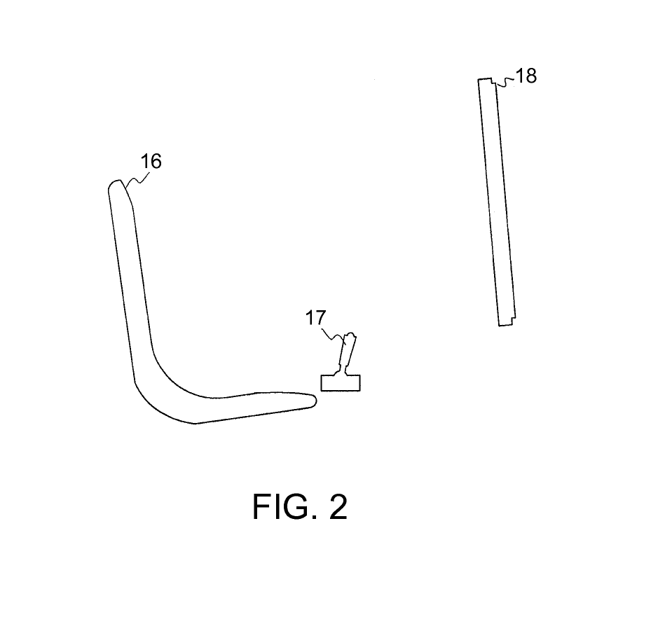

Machine 10 may include, among other things, a body 11 supported by one or more traction devices 12 and a propulsion system for propelling the traction devices. The propulsion system may include a prime mover 13, as shown generally by an arrow in FIG. 1 indicating association with the machine 10, and a transmission 14, as shown generally by an arrow in FIG. 1 indicating association with the machine 10, operatively connected to the prime mover. Machine may include a cab or operator station that an operator may physically occupy and provide input to operate the machine, Referring to FIG. 2, operator station 15 may include an operator seat 16, one or more input devices 17 through which the operator may issue commands to control the operation of the machine 10 such as the propulsion and steering as well as operate various implements associated with the machine. Operator station 15 may further include a visual image display device 18 such as fiat screen display.

Machine 10 may include a control system 20, as shown generally by an arrow in Fig, 1 indicating association with the machine 10. The control system 20 may utilize one or more sensors to provide data and input signals representative of various operating parameters of the machine 10 and the environment of the work site 100 at which the machine is operating, The control system 20 may include an electronic control module or controller 21 and a plurality of sensors associated with the machine 10.

The controller 21 may be an electronic controller that operates in a logical fashion to perform operations, execute control algorithms, store and retrieve data and other desired operations. The controller 21 may include or access memory, secondary storage devices, processors, and any other components for running an application. The memory and secondary storage devices may be in the form of read-only memory (ROM) or random access memory (RAM) or integrated circuitry that is accessible by the controller, Various other circuits may be associated with the controller 21 such as power supply circuitry, signal conditioning circuitry, driver circuitry, and other types of circuitry.

The controller 21 may be a single controller or may include more than one controller disposed to control various functions and/or features of the machine 10. The term “controller” is meant to be used in its broadest sense to include one or more controllers and/or microprocessors that may be associated with the machine 10 and that may cooperate in controlling various functions and operations of the machine. The functionality of the controller 21 may be implemented in hardware and/or software without regard to the functionality. The controller 21 may rely on one or more data maps relating to the operating conditions and the operating environment of the machine 10 and the work site 100 that may be stored in the memory of controller. Each of these data maps may include a collection of data in the form of tables, graphs, and/or equations.

The control system 20 may be located on the machine 10 and may also include components located remotely from the machine such as at a command center not shown). The functionality of control system 20 may be distributed so that certain functions are performed at machine 10 and other functions are performed remotely. In such case, the control system 20 may include a communications system such as wireless network system (not shown) for transmitting signals between the machine 10 and a system located remote from the machine.

Machine 10 may be equipped with a plurality of machine sensors 22, as shown generally by an arrow in FIG. 1 indicating association with the machine 10, that provide data indicative (directly or indirectly) of various operating parameters of the machine and/or the operating environment in which the machine is operating. The term “sensor” is meant to be used in its broadest sense to include one or more sensors and related components that may be associated with the machine 10 and that may cooperate to sense various functions, operations, and operating characteristics of the machine and/or aspects attic environment in which the machine is operating.

A position sensing system 23, as shown generally by an arrow in FIG. 1 indicating association with the machine 10, may include a position sensor 24 to sense a position of the machine relative to the work site 100. The position sensor 24 may include a plurality of individual sensors that cooperate to provide signals to controller 21 to indicate the position of the machine 10. In one example, the position sensor 24 may include one or more sensors that interact with a positioning system such as a global navigation satellite system or a global positioning system to operate as a position sensor. The controller 21 may determine the position of the machine 10 within work site 100 as well as the orientation of the machine such as its heading, pitch and roll. In other examples, the position sensor 24 may be an odometer or another wheel rotation-sensing sensor, a perception based system, or may use other systems such as lasers, sonar, or radar to determine the position of machine 10.

In some instances, the operator station 15 may be positioned to minimize blind spots of machine 10 (i.e., maximize the unobstructed area viewable by an operator or operators of machine 10). However, because of the size and configuration of some machines 10, the blind spots may be relatively large. As a result, obstacles or objects may sometimes be located within a blind spot and thus not directly visible to an operator.

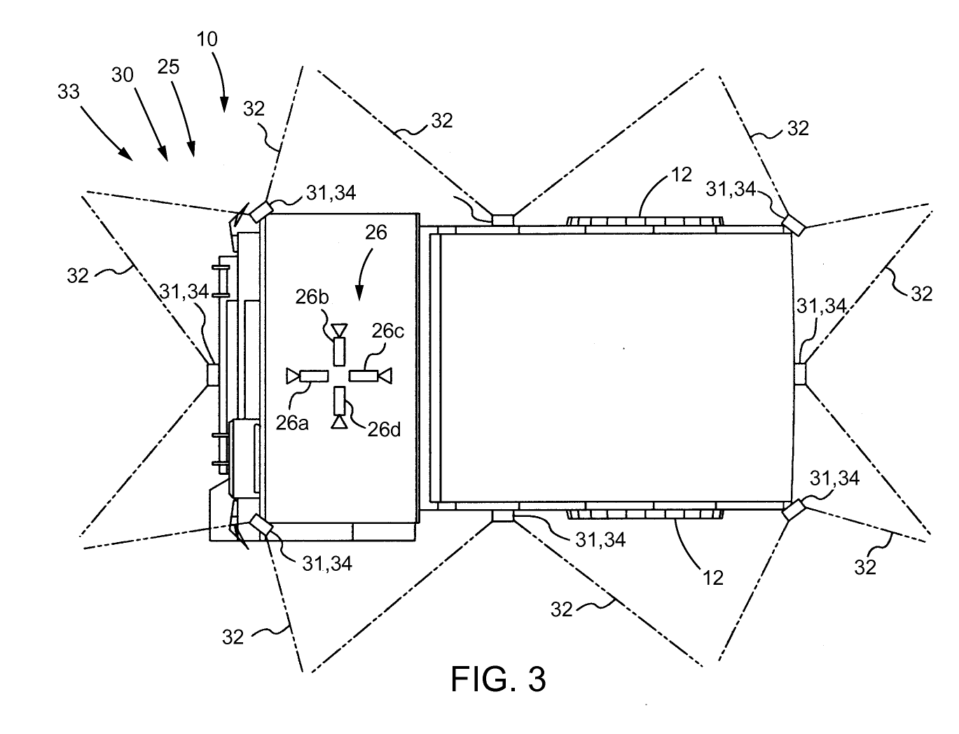

To increase the operator's field of view of the area surrounding the machine, machine 10 may include a visual image system 25 mounted on or associated with the machine, as shown generally by an arrow in FIG. 3 indicating association with the machine 10. The visual image system 25 may include a plurality of visual image sensors such as cameras 26 for generating image data. from a plurality of points of view relative to the machine 10. The visual image system 25 may be used to display views of the environment around machine 0 on a visual image display device 18 within the operator station 15 of machine 10.

Each camera 26 may be mounted on the machine 10 at a relatively high vantage point such as at the top of the frame of the machine or the roof. As depicted schematically in FIG. 3, four cameras 26 are provided that record or sense images in the forward and rearward directions as well as to each side of machine 10. In the embodiment depicted in FIG. 1, the cameras 26 may be positioned in other locations but may face in the same directions as depicted in FIG. 3, Controller 21 may receive image data from the cameras 26 and generate video or still images based upon such images.

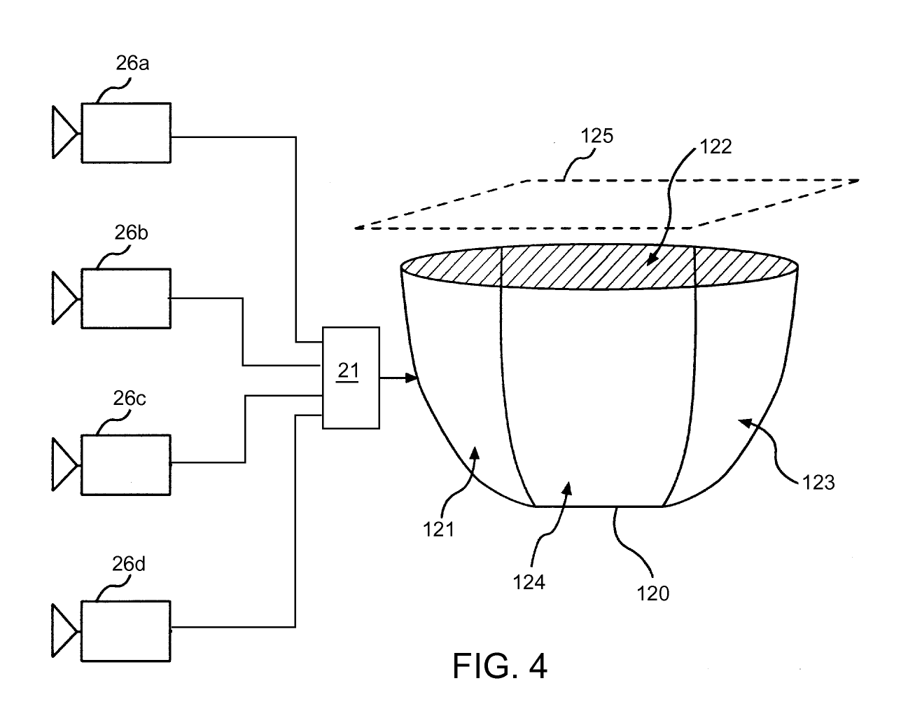

In some embodiments, controller 21 may combine the image data captured by the cameras 26 into a unified image 120 of a portion of the work site 100 adjacent and surrounding the machine 10 depicted. FIG. 4 is a pictorial illustration of one example of controller 21 combining image data from each of the cameras 26 to generate the unified image 120. The unified image 120 may represent all image data available for the environment of machine 10. In one example, the unified image 120 represents a 360-degree view or model of the environment of machine 10, with machine 10 at the center of the 360-degree view. According to some embodiments, the unified image 120 may be a non-rectangular shape. For example, the unified image 120 may be hemispherical and machine 10 may be conceptually located at the pole, and in the interior, of the hemisphere.

Controller 21 may generate the unified image 120 by mapping pixels of the image data captured by the cameras 26 to a pixel map. The pixel map may be divided into sections, with each section corresponding to one set of image data, For example, as shown in FIG. 3, front or first camera 26a captures image data that is mapped to section 121, right or second camera 26b captures image data that is mapped to section 122, rear or third camera 26c captures image data that is mapped to section 123, and left or fourth camera 26d captures image data that is mapped to section 124. Pixels may be mapped directly using a one-to-one or one-to-many correspondence, and the mapping may correlate a two dimensional point from the image data to a three dimensional point on the map used to generate the unified image 120, For example, a pixel of the image data located at (1,1) may be mapped to location (500, 500, 1) of the unified image. The mapping may be accomplished using a look-up table that may be stored within controller 21, The look-up table may be configured based on the position and orientation of each camera 26 on machine 10. Although a look-up table is one method by which controller 21 may map the image data to the unified image 120, those skilled in the art will appreciate that other methods for mapping image data may be used to achieve the same effect.

Controller 21 may also use parameters associated with cameras 26 to map pixels from the image data to the unified image 120. The parameters may be included metadata of the image data. For example, the parameters may include the position of each camera 26 with respect to machine 10. Controller 21 may correlate sections 121-124 of the unified image 120 with machine 10, and controller 21 may use the correlations to determine which of the image data to map to each section. For example, controller 21 may correlate section 121 with the front of machine 10, When the controller receives image data from front or first camera 26a, the parameters included in the metadata associated with such image data may indicate that it was captured by first camera 26a. The parameters may also indicate that first camera 26a is positioned on the front of machine 10. Controller 21 may analyze the parameters and determine that certain image data should be mapped to section 121. Thus, as controller 21 accesses the image data, it can correctly map it to sections 121-124 of the unified image 120, Other manners of generating a unified image are contemplated.

Controller 21 may be configured to select a portion of the unified image 120 for rendering on visual image display device 18 within operator station 15 and/or another display (not shown). The portion may be selected using a designated viewpoint, The viewpoint 125 depicted in FIG. 3 represents a plane from which the unified image 120 may be viewed, and the pixels located under the plane form the portion of the unified image 120 that controller 21 renders on visual image display device 18. For example, as shown in FIG. 3, viewpoint 125 is positioned above the entire unified image 120, and all of the pixels of the unified image are located under viewpoint 125. With this designated viewpoint, the unified image is configured as a birds-eye or overhead view with the machine 10 centered therein and such image may be rendered on visual image display device 18,

Other viewpoints may be used to generate an image to be displayed. For example, the viewpoint 125 may be shifted laterally relative to the unified image 120 to provide a larger field of view of one portion or side of the operating environment around the machine 10. In such case, the controller 21 may render a shifted bird's eye view which is based upon the bird's eye view, but with the machine shifted relative to the unified image 120. This may be desirable to emphasize the existence or details of objects detected on one or two sides of machine 10. In another example, controller 21 may generate images from a single point of view or direction such as by displaying an image indicative of image data from only one camera 26, Such viewpoint may be referred to as a directional view as it may correspond to a direction relative to the machine 10. In some circumstances, a directional view may be generated by data from a. combination of two or more cameras 26. In some instances, a directional view may correspond to a state of the machine (e.g., correspond to a direction that the machine is moving or a state of the transmission such as neutral, drive, or reverse).

While operating at work site 100, machine 10 may encounter one or more obstacles 101. Obstacle 101 may embody any type of object including those that are fixed or stationary as well as those that are movable or that are moving. Examples of fixed obstacles may include infrastructure, storage, and processing facilities, buildings, and other structures and fixtures found at a work site. Examples of movable obstacles may include machines, light duty vehicles (such as pick-up trucks and cars), personnel, and other items that may move about work site 100.

To reduce the likelihood of a collision between machine 10 and an obstacle 101, an object detection system 30 may be mounted on or associated with the machine, as shown generally by an arrow in FIG. 3 indicating association with the machine 10. The object detection system 30 may include a radar system, a SONAR system, a LIDAR system, and/or any other desired system together with associated Object detection sensors 31. Object detection sensors 31 may generate data that is received by the controller 21 and used b the controller to determine the presence and position of obstacles 101 within the range of the sensors. The range of each object detection sensor 31 is depicted schematically in FIG. 3 by reference number 37.

An object identification system 33 may be mounted on or associated with the machine in addition to the object detection system 30, as shown generally by an arrow in FIG. 3 indicating association with the machine 10. In some instances, the object detection system 30 and the object identification system 33 may be integrated together. Object identification sensors 34 may generate data that is received by the controller 21 and used by the controller to determine the type of obstacles detected by the object detection system 30. The object identification sensors 34 may be part of or replace the object detection sensors and thus are depicted schematically as the same components in FIG. 3. In an alternate embodiment, the object identification sensors may be separate components from the object detection sensors 31.

The object identification system 33 may operate to differentiate categories of object detected such as machines, light duty vehicles, personnel, or fixed objects.

in sonic instances, the object identification system 33 may operate to further identify the specific object or type of object detected.

Object identification system 33 may be any type of system that determines the type of object that is detected. In one embodiment, the object identification system 33 may embody a computer vision system that uses edge detection technology to identify the edges of a detected object and then matches the detected edges with known edges contained within a. data map or database to identify the object detected. Other types of object identification systems and methods of object identification are contemplated.

In an alternate or supplemental embodiment, controller 21 may include or access an electronic map of the work site 100 including the position of machine 10 and the positions of various known obstacles 101 at the work site. The object detection system 30 may utilize the electronic map of the work site 100 together with the position data of the machine from the position sensing system 23 to determine the proximity of the machine to any obstacles 101. The electronic map of the work site 100 may also include the type of object in addition to its location and the object identification system 33 may use this information to determine the type of obstacle 101 at the work site.

Still further, the object identification sensors 34 may comprise RFID sensors and certain objects or obstacles 101 at the work site 100 may be equipped with MD chips or tags (not shown). The object identification system 33 may be configured to read RFID chips of any obstacles 101 that are within a predetermined range to identify such obstacles.

Visual image system 25 and object detection system 30 may operate together to define an image display system 35, as shown generally by an arrow in FIG. 3 indicating association with the machine 10. Object identification system 33, if present, may also operate as a part of the image display system 35.

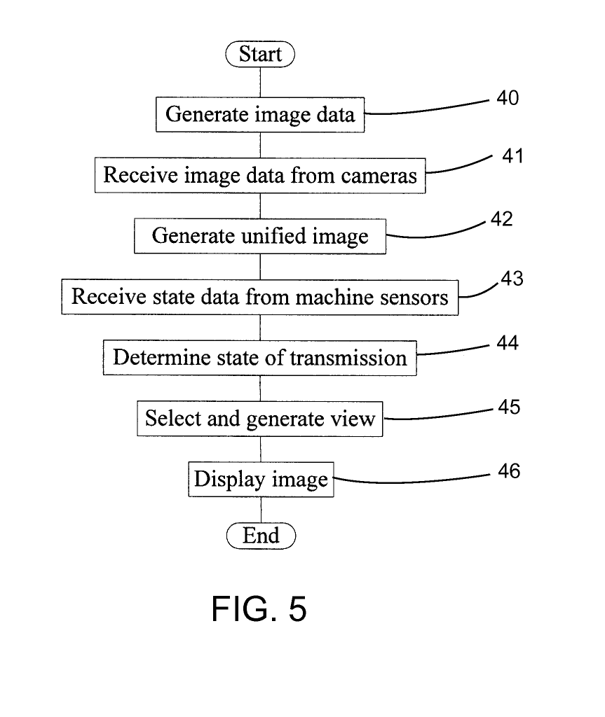

Referring to FIG. 5, a flowchart of the operation of the image display system 35 is depicted. During the operation of machine 10, cameras 26 generate image data at stage 40 and controller 21 receives at stage 41 the image data from the cameras. Inasmuch as the cameras 26 face in a multiple directions, image data may be generated depicting the operating environment surrounding the machine 10. The image data may include images captured by cameras 26, as well metadata including parameters associated with each of cameras 26. The parameters may describe the orientation of each camera 26, the position of each camera with respect to machine 10, and the range of each camera's field of view.

At stage 42, controller 21 may use the image data to generate a unified image 120 of the operating environment of machine 10 by combining the image data generated by the cameras 26 as described in more detail above. Controller 21 may receive at stage 43 state data from various machine sensors associated with the machine 10. For example, the state data may include the direction of travel and the speed of movement of the machine as well as the gear or setting of the transmission 14. The controller 21 may determine at stage 44, the state of the transmission 14.

Once controller 21 has generated the unified image 120, the controller may select and generate at stage 45 a view based upon a portion of the unified image 120, a directional view from one or more of the cameras 26, or some other image to be rendered on the visual image display device 18. The controller 21 may select the image to be rendered based upon a plurality of factors including the number of and proximity to any objects detected adjacent the machine 10, the state of the transmission 14, and the identity of any objects detected. At stage 46, controller 21 may render the image on the visual image display device 18.

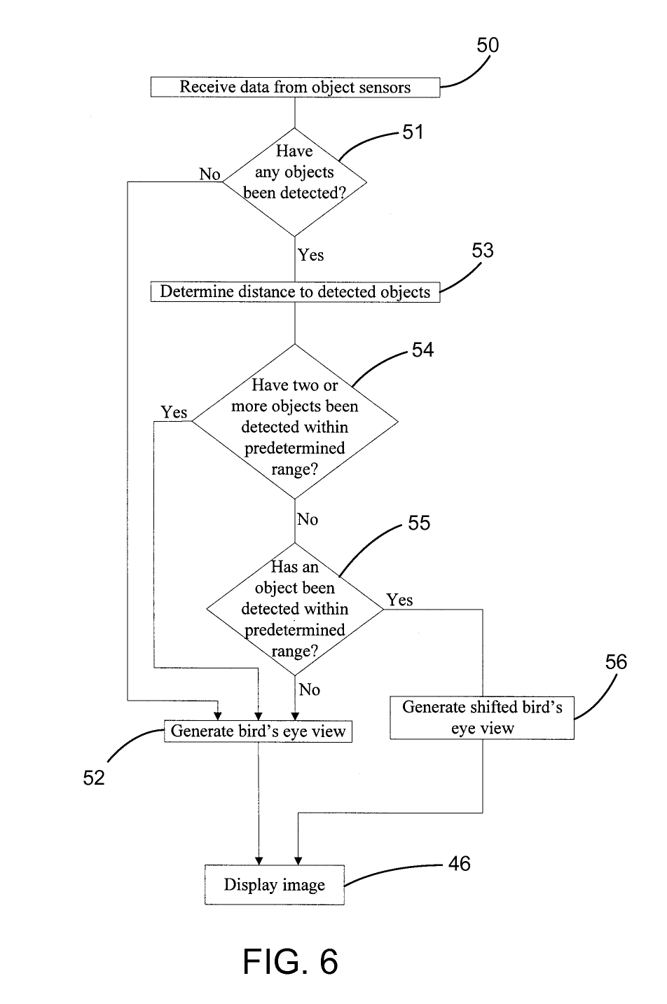

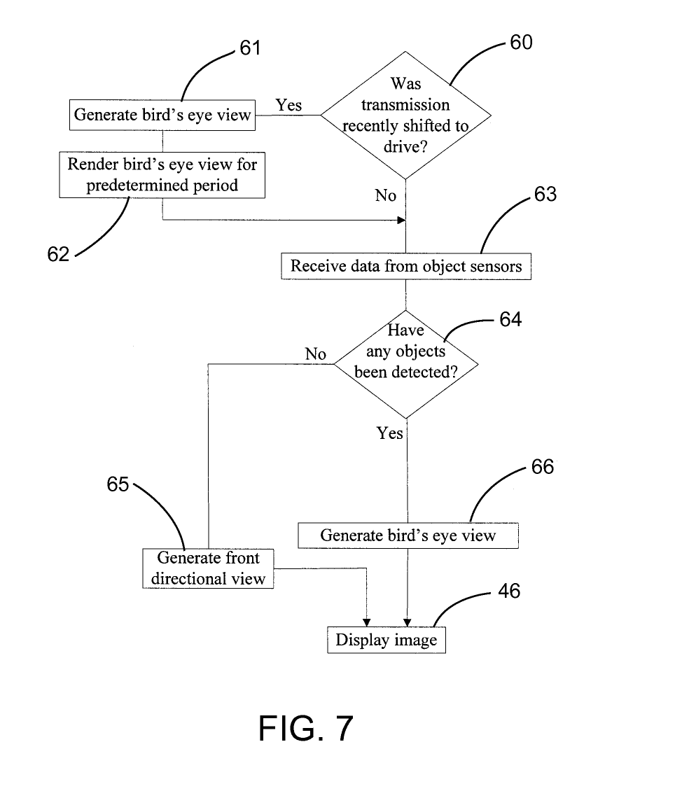

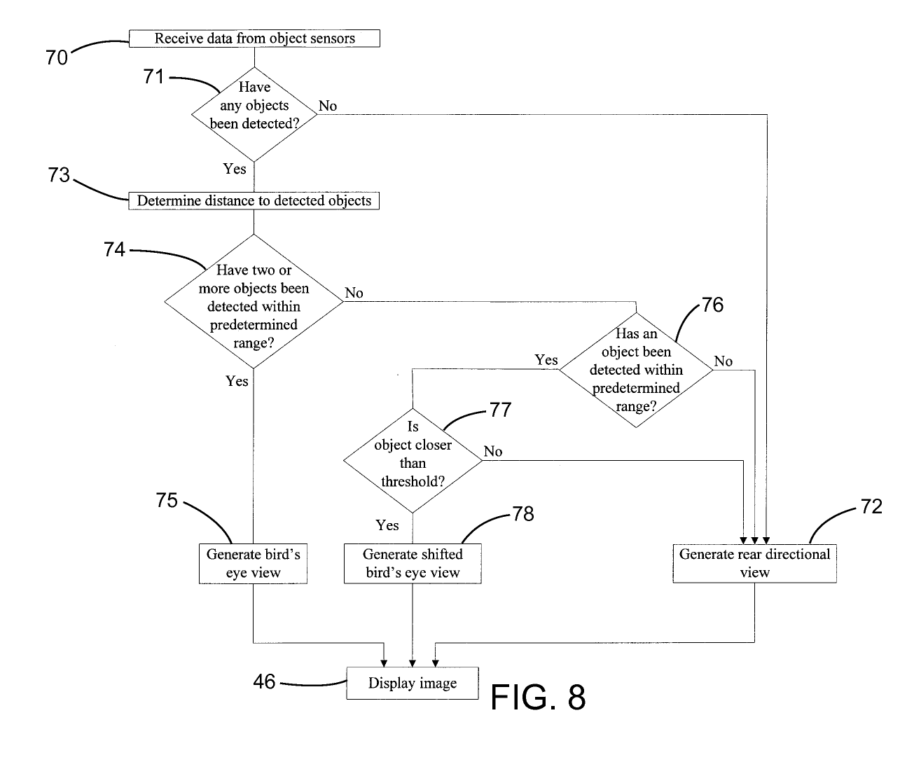

FIGS. 6-8 depict examples of processes used by the image display system 35 to select the views at stage 45 based upon the state of the transmission 14. FIG. 6 depicts an example of a process while the transmission is in neutral or park, FIG. 7 depicts an example of a process while the transmission is in drive or a forward gear, and FIG. 8 depicts an example of a process while the transmission is in reverse.

Referring to FIG. 6, with the transmission 14 in neutral or park, object detection sensors 31 generate data and controller 21 receives at stage 50 the data from the object detection sensors. At stage 51, the controller 51 determines whether any objects are detected within the range of object detection sensors 31. If no objects are detected, the controller may generate at stage 52 a bird's eye or overhead view of the area surrounding the machine 10 that depicts the machine centered within the bird's eye view. The bird's eye view with the machine 10 centered therein is referred to herein as a standard bird's eye view.

If objects are detected at stage 51, the controller 21 may at stage 53 determine the distance from any detected objects to the machine 10. If the controller 21 determines at stage 54 that two or more objects are within a predetermined range from the machine 10, the controller may generate at stage 52 a standard bird's eye view of the area surrounding the machine 10. Such bird's eye view will permit an operator within operator station 15 to see all of the Obstacles within the predetermined range and their proximity to machine 10. In some instances, it may be desirable to zoom the standard bird's eye view to some extent while still maintaining all of the objects within the image.

If the controller 21 determines at stage 54 that two or more objects are not within a predetermined range from the machine 10, the controller may determine at stage 55 whether a single object is within the predetermined range from the machine. no objects are detected within the predetermined range, the controller 21 may generate at stage 52 a standard bird's eye view of the area surrounding the machine 10. If only one object is detected within the predetermined range from the machine 10, the controller 21 may generate at stage 56 a modified image such as a shifted bird's eye view in which the bird's eye view is shifted towards the object and the machine 10 is no longer centered within the view. In an alternate embodiment, the controller 21 may generate a directional view in which the images from one or more cameras 26 are rendered on visual image display device 18.

Once the controller 21 determines the image to be displayed and generates such image at stages 52 or 56, the controller 21 may render the image on visual image display device 18 at stage 46,

FIG. 7 depicts a process for selecting a view to be generated while the transmission 14 is in drive or a forward gear. When moving the machine 10 forward, an operator typically has some range of view from the operator station 15 such that objects in front of the machine that are relatively far away are visible. In other words, while objects that are very close to the machine 10 may be within a blind spot, objects that are in front of the machine but farther away are likely to be visible to an operator within the operator station 15. As the machine 10 moves forward, the operator will likely be aware of objects in front of the machine based upon the operator's memory even if such objects are in a blind spot. However, if the machine has been stationary or moving in reverse, it is possible that one or more movable objects may have moved into a blind spot in front of the machine without the knowledge of the operator. Accordingly, when the transmission 14 is initially shifted into drive or a forward gear, it may be desirable to provide additional assistance to the operator by displaying any objects that are in proximity to or adjacent the machine 10.

At stage 60, the controller 21 determines whether the transmission 14 was recently shifted into a drive or a forward gear. As used herein, recently may refer to a predetermined period of time or a predetermined distance the machine 10 has traveled since being shifted into drive or a forward gear. In one example, the predetermined distance may be two to five meters, If the transmission 14 was recently shifted into a drive or a forward gear, a movable object may have moved into a blind spot of the machine 10 while the machine was stationary or in a reverse gear. In either case, the operator may not be aware of the object in the blind spot. Accordingly, if the transmission 14 was recently shifted into a drive or a forward gear, the controller 21 may generate at stage 61 a bird's eye view and display or render the bird's eye view on visual image display device 18 at stage 62.

If the transmission 14 was not recently shifted into drive or a forward gear, the object detection sensors 31 generate data and controller 21 receives at stage 63 the data from the object detection sensors. At stage 64, the controller 51 determines whether any Objects are within the range of object detection sensors 31. If no objects are detected, the controller 21 may generate at stage 65 a front directional view including an image from the front or first camera 26a. If desired, images from the right or second camera 26b and the left or fourth camera 26d may be combined with the image from the first camera 26a to expand the field of

If one or more objects are detected at stage 64, the controller 21 may generate at stage 66 a standard bird's eye view of the area surrounding the machine 10. Such bird's eye view will permit an operator within operator station 15 to see all of the obstacles and provide some degree of spatial relationship between the detected object or objects and the machine 10. In some instances, it may be desirable to zoom the standard bird's eye view to some extent while still maintaining all of the detected objects within the image.

Once the controller 21 determines the image to be displayed and generates such image at stages 65 or 66, the controller 21 may render the image on visual image display device 18 at stage 46.

FIG. 8 depicts the process for selecting a view to be generated while the transmission 14 is in reverse. Object detection sensors 31 generate data and controller 21 receives at stage 70 the data from the object detection sensors. At stage 71, the controller 51 determines whether any objects are detected within the range of the object detection sensors 31. If no objects are detected, the controller may generate at stage 72 a rear directional view including an image from the rear or third camera 26c. If desired, images from the right or second camera 26b and the left or fourth camera 26d may be combined with the image from the rear or third camera 26c to expand the field of vision.

If objects are detected at stage 71, the controller 21 may at s age 73 determine the distance from any detected objects to the machine 10.

If the controller 21 determines at stage 74 that two or more objects are within a predetermined range from the machine 10, the controller may generate at stage 75 a standard bird's eye view of the area surrounding the machine 10. Such bird's eye view will permit an operator within operator station 15 to see all of the obstacles within the predetermined range and their proximity to machine 10. In some instances, it may be desirable to zoom the standard bird's eye view to some extent while still maintaining all of the objects within the view.

If the controller 21 determines at stage 74 that two or more objects are not within a predetermined range from the machine 10, the controller may determine at stage 76 whether a single object is within the predetermined range from the machine. If no objects are detected within the predetermined range, the controller 21 may generate at stage 72 a rear directional view from the rear or third camera 26c. if desired, images from the right or second camera Nib and the left or fourth camera 26d may be combined with the image from the rear or third camera 26c to expand the field of vision.

If one object is detected within the predetermined range from the machine 10, the controller 21 may determine at stage 77 whether the object is closer than a predetermined threshold. If the object is not closer than the predetermined threshold, the controller 21 may continue to generate at stage 72 the rear directional view. If the machine 10 continues to move rearwardly towards the object or the relative distance between the machine and the object otherwise is decreased to less than the predetermined threshold, the controller 21 may generate a modified image such as a shifted bird's eye view in which the bird's eye view is shifted towards the detected object.

Once the controller 21 determines the image to be displayed and generates such image at stages 72, 75, or 78, the controller 21 may render the image on visual image display device 18 at stage 46.

In some instances, even if the controller 21 determines that more than one object has been detected, the processes depicted in FIGS. 6-8 may be performed as if only a single object was detected. More specifically, the controller 21 may analyze the positions of the plurality of detected objects to determine whether the detected objects are within a predetermined field of view or a predetermined distance from each other. If all of the objects detected are within a predetermined field of view or close enough together, the view selection process may operate as if only a single object were detected. This may occur, for example, if the objects are close enough together that they are all visible with a directional view from cameras 26.

The image to be selected may also be dependent on the state of the machine 10 and/or the state of the detected objects. More specifically, the controller 21 may monitor the speed and direction of movement of the machine 10 as well as the speed and direction of movement of any detected objects and use such information to determine which views to select. In one example, if relative movement of the machine 10 is away from a detected object, the controller 21 may be configured to disregard the detected object and the view selection process proceeds as if no objects were detected. This may occur is the machine 10 is moving and the detected object is stationary, the machine is stationary and the detected object is moving, or both are moving in such a manner that that results in relative movement away from each other. In an example in which two Objects are detected, the controller 21 may disregard the detected object that is moving relatively away from the machine 10 so that the view selection process operates as if only one object were detected. In still another example, the relative speeds between a detected object and machine 10 may be monitored so that the view selection process may disregard a detected object if it is passing by machine 10 relatively quickly and the object is at least a predetermined distance away.

If the image display system 35 includes an object identification system 33, the view selection process may also use the identification of the detected objects to determine the view to be selected. For example, the controller 21 may select different views depending on whether the detected objects are fixed or movable obstacles and whether any movable obstacles are machines, light duty vehicles or personnel.

In addition, controller 21 may be configured to add additional detail to a rendered image such as an overlay based upon the type of Object detected and the distance to such object. For example, different color overlays may be used depending on the type of object detected and the color may change depending on the distance to such object, If desired, aspects of the overlay may also flash or change to provide an additional visual warning to an operator.

Overlays may also be task-based to assist in operating machine 10 such as by rendering a target position and a target path to assist an operator in completing a desired task, In one example, an overlay may be used to assist in positioning a haul truck for loading by a wheel loader. In such case, the object detection system 30 and the object identification system 33 may detect and identify the wheel loader. The image display system 35 may render a rear directional view on visual image display device 18 that includes images from the rearwardly facing third camera 26c as well as the second camera 26b and the fourth camera 26d. An overlay may be depicted or rendered on the visual image display device 18 highlighting certain components of the wheel loader and a target position for the haul truck as well projecting a desired path of the haul truck. If desired, once the haul truck is within a predetermined distance from the wheel loader, the depicted view may change to a shifted bird's eye view to assist in aligning the haul truck and the wheel loader along multiple axes.

### INDUSTRIAL APPLICABILITY

The industrial applicability of the system described herein will be readily appreciated from the foregoing discussion. The foregoing discussion is applicable to machines 10 that are operated at a work site 100 and include an image display system 35. The image display system 35 may be used at a mining site, a landfill, a quarry, a construction site, a roadwork site, a forest, a farm, or any other area in which it is desired to improve the visibility of a machine operator.

The image display system 35 may include a visual image system 25 mounted on a machine 10 for generating image data from a plurality of points of view relative to the machine and an object detection system 30 associated with the machine for detecting Objects in proximity to the machine. In addition, a plurality of machine sensors 22 may be associated with the machine 10 for sensing a state of the machine. The controller 21 may be configured to receive image data from the visual image system 25 and generate a unified image 120 by combining the image data from the plurality of points of view, determine an image to be displayed based upon the state of the machine 10 and any objects detected in proximity to the machine, and render the image on a visual image display device 18.

Image display system 35 provides a system to enhance the awareness of an operator of machine 10 to objects adjacent the machine. A unified image 120 is generated and an image to be rendered is determined base upon based upon the state of the machine 10 and any objects detected in proximity to the machine. In one example, the image to be rendered is based upon the state of the transmission 14 of the machine 10.

It will be appreciated that the foregoing description provides examples of the disclosed system and technique. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. An image display system comprising:
a visual image system mounted on a machine for generating image data from a plurality of points of view relative to the machine;
an object detection system associated with the machine for detecting objects in proximity to the machine;
a machine sensor associated with the machine for sensing a state of the machine; and
a controller configured to:
receive the image data from the visual image system;
generate a unified image by combining the image data from the plurality of points of view;
detect any objects in proximity to the machine;
sense a state of the machine;
determine an image to be rendered based upon the state of the machine and any objects detected in proximity to the machine; and
render the image on a visual image display device.

2. The image display system of claim 1, wherein the image to be rendered is chosen from one of a bird's eye view based upon the unified image with the machine centered therein, a shifted bird's eye view based upon the unified image with the machine shifted relative to the unified image, and a directional view corresponding to a state of the machine.

3. The image display system of claim 2, wherein the state of the machine is a setting of a transmission of the machine.

4. The image display system of claim 3, wherein the image to be rendered is a rear directional view when the transmission of the machine is in reverse and an object has not been detected in proximity to the machine and the image to be rendered is a front directional view when the transmission of the machine is in drive and an object has not been detected in proximity to the machine.

5. The image display system of claim 1, wherein the image to be rendered is a bird's eye view based upon the unified image with the machine centered therein if zero or more than one object is detected within a first predetermined distance from the machine.

6. The image display system of claim 5, wherein the image to be rendered is a bird's eye view based upon the unified image with the machine offset therein if only one object is detected within the first predetermined distance from the machine.

7. The image display system of claim 6, wherein upon the controller determining that a transmission of the machine is in reverse and only one object is detected within the first predetermined distance from the machine, the image to be rendered is a rear directional view relative to the machine if the only one object is more than a second predetermined distance from the machine, the second predetermined distance being less than the first predetermined distance, and the image to be rendered is a shifted bird's eye view based upon the unified image if the only one object is less than the second predetermined distance from the machine,

8. The image display system of claim 1, wherein further including an object identification system to determine a type of object detected in proximity to the machine and the controller determines the image to be rendered based upon the type of object detected.

9. The image display system of claim 8, wherein the controller is further configured to determine an overlay based upon on the type of object detected and to render the overlay on the visual image display device.

10. The image display system of claim 1, wherein the visual image system includes a plurality of cameras.

11. The image display system of claim 10, wherein each of the plurality T points of view correspond to one of the plurality of cameras.

12. A controller-implemented method of operating an image display system comprising:
receiving image data from a visual image system mounted on a machine for generating image data from a. plurality of points of view relative to the machine;
generating a unified image by combining the image data from the plurality of points of view;
detecting any objects in proximity to the machine;
sensing a state of the machine based upon a machine sensor associated with the machine;
determining an image to be rendered based upon the state of the machine and any objects detected in proximity to the machine; and
rendering the image on a visual image display device.

13. The method of claim 12, further including choosing the image to be rendered from one of a bird's eye view based upon the unified image with the machine centered therein, a shifted bird's eye view based upon the unified image with the machine shifted relative to the unified image, and a directional view corresponding to a state of the machine.

14. The method of claim 13, further including rendering a rear directional view when a transmission of the machine is in reverse and an object has not been detected in proximity to the machine and rendering a front directional view when the transmission of the machine is in drive and an object has not been detected in proximity to the machine.

15. The method of claim 12, further including rendering a bird's eye view based upon the unified image with the machine centered therein if zero or more than one object is detected within a first predetermined distance from the machine.

16. The method of claim 15, further including rendering a bird's eye view based upon the unified image with the machine offset therein if only one object is detected within the first predetermined distance from the machine.

17. The method of claim 16, wherein upon determining that a transmission of the machine is in reverse and detecting only one object within the first predetermined distance from the machine, rendering a rear directional view relative to the machine if the only one object is more than a second predetermined distance from the machine, the second predetermined distance being less than the first predetermined distance, and rendering a shifted bird's eye view based upon the unified image if the only one object is less than the second predetermined distance from the machine.

18. The method of claim 12, wherein further including determining a type of object detected in proximity to the machine and determining the image to be rendered based upon the type of object detected.

19. The method of claim 18, further including determining an overlay based upon on the type of object detected and to render the overlay on the visual image display device.

20. A machine comprising:
a propulsion system;
a visual image system mounted on the machine for generating image data from a plurality of points of view relative to the machine;
an object detection system associated with the machine for detecting objects in proximity to the machine;
a machine sensor associated with the machine for sensing a state of the machine; and
a controller configured to:
receive the image data from the visual image system;
generate a unified image by combining the image data from the plurality of points of view;
detect any objects in proximity to the machine;
sense a state of the machine;
determine an image to be rendered based upon the state of the machine and any objects detected in proximity to the machine; and
render the image on a visual image display device.
